(19) United States
(12) Patent Application Publication
(10) Pub. No.: US 2013/0040274 A1
(43) Pub. Date: Feb. 14, 2013

(54) INTEGRATED INTERACTIVE SYSTEM AND METHOD FOR VISUALIZING HUMAN PHYSIOLOGY, DISEASE, TREATMENT OPTIONS AND USE

(71) Applicants: MATTHIAS W. RATH, APTOS, CA (US); Aleksandra Niedzwiecki, APTOS, CA (US); Markus Haecki, Dortmund (DE)

(72) Inventors: MATTHIAS W. RATH, APTOS, CA (US); Aleksandra Niedzwiecki, APTOS, CA (US); Markus Haecki, Dortmund (DE)

(73) Assignee: MATTHIAS RATH, APTOS, CA (US)

(21) Appl. No.: 13/525,499

(22) Filed: Jun. 18, 2012

Related U.S. Application Data
(63) Continuation-in-part of application No. 13/209,382, filed on Aug. 13, 2011.

(51) Int. Cl. G09B 23/30; G09B 23/28

(52) U.S. Cl. 434/272; 434/267; 434/262

(57) ABSTRACT

A novel integrated system and method for visualizing human physiology, disease and treatment options are described in the instant application. The graphical rendering of the human body is in depth and the user can explore the internal workings of the organs and cells by simply performing a pealing like act using a cursor and the layer as a flap opens up to show the details. A user can click on a specific topic and watch a video, narration or text relevant to the topic of choice. The integrated system provides storage of curated data, social media access and interaction, database storage and analytics to calculate user behavior. This technology may used as an application on any mobile and hardware device.

### CROSS RELATED APPLICATIONS

The instant application is a continuation-in-part of a pending U.S. application Ser. No. 13/209,382, filed on 13, Aug. 2011. The pending U.S. application Ser. No. 13/209,382 is hereby incorporated by reference in its entireties for all of its teachings.

### FIELD OF TECHNOLOGY

This disclosure relates generally to a field of a modular visual and self learning tool, to be used as an integrated system and a method to explore human physiology, gain insight about a disease condition and treatment options, and interact with other users using the social media. More particularly, it relates to a social media enabled interactive tool that is useful for exploring, investigating, and comprehending the pathophysiology of a disease occurrence, progress and existing treatment options.

### BACKGROUND

Disparate web sites and reading materials are available for an individual to read about a disease, how it progresses and what the various comprehensive treatment options available are. This puts a tremendous burden on an individual, a patient and their family to perform research and get educated about their particular problem for understanding human physiology and particular disease conditions. There is need for an alternate format of informational tool that may be suitable for all ages and across several disciplines and demographics for a particular disease condition.

### SUMMARY

Several methods, tool and system for informational, integrated and interactive content for a general human physiology, a particular disease condition and treatment options using modular multimedia tools are disclosed. In one embodiment, the modular integrated tool renders informational material for medical, physiological and pathological conditions shown in the virtual human body at system level, organ level, cellular level and molecular level.

In one embodiment, the modular integrated tool uses a processor to display various functions and graphics. In another embodiment, the integrated tool uses a database to store and retrieve information that is being created, accessed, incorporated and viewed. In another embodiment the integrated tool dynamically gathers, updates and presents data for a particular display related to human physiological display for normal, disease and treatment conditions.

In one embodiment, a user can interactively search, communicate, import, visualize, select and annotate the content they view, create, query and store through the user module. In another embodiment, an analytical module comprises of and enables an individual (user, administrator, creator etc.) to administer, create word and/or image module, relevance ranking using relevance module, analysis module, navigation module, filtering module, database module, output module, organization module, query module, output module, rating module and lingual analysis module. The analytical module is modular, scalable and interchangeable and may not be limited to just the referenced modules.

In one embodiment, the system module comprises of search engine module, security module, data integration module, storage module, knowledge module, integration module, display module, statistics module, network module, update module and interactive module.

In one embodiment, the informational tool is generated using modules for graphical illustration, narrations, means for participation and collaboration. In another embodiment, the informational tool may be used as an educational means for a user to learn, explore, educate and interact with other users.

In one embodiment, a user can participate in creating the content, study the content, share the content and interactively use the content. The user may also travel or tour the virtual human body to explore at a physiological system level, organ level, cellular level and molecular level. In another embodiment, the user may interactively observe, change and learn effect of modulation of at least one of micronutrients, drugs, environmental toxins and pathogen levels and their effect on cellular level, organ level and entire human body level. Micronutrients may be, not limited to, vitamins, amino acids, supplements, drugs may be chemotherapy drugs, antibiotics, antihistamines, steroids etc, other pharmaceutical drugs, pathogens may be virus, bacteria, etc. In another embodiment, the user may also select from the prepared content modules to observe a progression of a disease at a molecular level, cellular level, organ level or at a human body system level.

In one embodiment, a developer, an user and a professional (such as scientist, physician but not limited to) and an involved participant such as a parent or a physician or a nurse may connect with each other using the informational tool to clarify, teach and observe the social media interaction and guide the other participants in an educational process of understanding the physiological condition, pathological condition and simple mechanism of physiological functions. The user may be a student, patient and/or an engineer, or any other person with permission who creates the modules.

In one embodiment, in a social media environment or an internet connected environment an advisor or a service provider may be able to advertise for a specific drug, micronutrient or a supplement, food for a particular physiological condition. The user may, for the current instance, be able to get the address, location or directions to the nearest store or place of treatment for a particular good or treatment condition. The current instance example may be the user is reading about effect of micronutrients such as vitamins, micronutrients and their sources and the service provider may display an advertisement on the side where and how to get to a location where the user can find such products.

In one embodiment, the informational tool may display the graphics in a three dimensional view. In another embodiment, the graphics may be rotated, scripts requested and narration switched on and off.

In one embodiment, method to explore a physiological development of the disease or function of the cell during a disease progression or normal conditions is described. In another embodiment, a user can input a search term either in the form of words or an image into the informational tool as a start. In one embodiment, the user specific search term may be used to collect user specific metrics, and/or used for relevance ranking and/or retrieving pertinent data from the web and/or the database. In another embodiment, user approach or behavior based or search strategies or terms used by the user may be used for calculating user approach relevance. In another embodiment, retrieval of pertinent data may be done dynamically, and/or stored data that may be curated and/or expert input from social media, print or web.

In another embodiment, display of results or video or any format of results based on user query may be done using various modules and traditional programs that enable interaction, multidimensional display and movable images. In another embodiment, the user may choose to use the narration in the language of choice, text display with and without narration and visual display of selection if they want to change the selection of topic.

In one embodiment, there is an interrelationship between user input, analysis module and system module. The user and hardware behavior flow is connected using hardware, web and databases.

In another embodiment, the user can understand the different functionality of micronutrients affecting the microenvironment of the cells or pharmaceutical drug and their effects of modulation in the cell by being present as a component of a cell, foreign object, or a cellular organelle.

In one embodiment, a method to explore a virtual human body is described. In another embodiment, a user can enter the human body at a system level and explore the circulatory system for example. In another embodiment, a user can take any form or a robot form and get into the cellular structure and visualize and learn about the various functions of the different components of the cellular system. In another embodiment, the user can understand the different functionality of micronutrients affecting the microenvironment of the cells and their effects of modulation in the cell by being present as a component of a cell, foreign object, or a cellular organelle.

In another method, the user can observe the formation of a disease state such as an atherosclerotic plaque in the walls of an artery or a cancer tumor.

In one embodiment, one may create a virtual human body as a modular multimedia tool for an individual to study, train, teach, learn and investigate using a machine readable media. In another embodiment one may enable the individual to choose a position to enter the virtual human body and travel and investigate through at least one of the cellular level, organ level and/or a system level. The user can connect with a social media tool to at least one other user to interact and travel through the virtual human body to understand the disease progression or study therapeutic intervention for example for educational purposes.

In another embodiment, a method includes creating a content to comply with a local authority rule, embedding the content to a user profile, a user preferred media and/or a user preferred time, and automatically updating the content on a periodic basis based on a local authority rule change, a change in user profile and/or a media change. The method also includes presenting a solution to a user generated query by an author, analyzing an evaluation form submitted by the user in compliance with a local authority rule using a processor and processing the evaluation form for a specific task in response to the local authority rule. In addition, the method also includes recording the evaluation form to perform retrieval, an archival and a reporting, and updating the evaluation form as a record for one or more of the retrieval, the archival and/or the reporting for a local authority such as a public health inspectors, regulatory authorities and/or companies. Further, the method may also include supporting a media device, a mobile device, a computer and/or a communication device, and enabling a local authority to access the record of a user of choice.

In one embodiment, a method may also allow the individual in acquiring data about a disease diagnosed by a physician in detail using the modular informational tool created for the virtual human body, viewing a progression of the disease diagnosed by the physician in detail and learning the implications of a natural progression of the disease, researching the implication of the proposed treatment plan and browsing at least one of a blog, social media group, user group and alternative treatment sites, and deciding on a treatment method plan with the physician. This would provide a decision making ideas for the individual, who may be a patient, relative or advisor. The method, in one embodiment, allows the user to access preventive and treatment methods, implications, and product specification, their availability, and the pharmacies or nearest store or commercial outlet to obtain the products.

In another embodiment, the whole set of modules may be created and run on a hardware such as a server or computer or a mobile device operating system to display use and upload to transform the content.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a view of an integrated system for disease management 100 illustrating communication between user and the server through a network, according to one embodiment.

FIG. 2 illustrates an exploded view of the disease management module 200, according to one embodiment.

FIG. 3 illustrates an exploded view of a user module 201, according to one embodiment.

FIG. 4 is an exploded view of the analytical module 202, according to one embodiment.

FIG. 5 is an exploded view of system module 203, according to one embodiment.

FIG. 6 is a representation of the user flow chart 600, according to one embodiment.

FIG. 7 is a representation of user and hardware behavior flow 700, according to one embodiment.

FIG. 8 is a diagrammatic system view of a computer device view in which any of the embodiments disclosed herein may be performed, according to one embodiment.

FIG. 9 is a view of cancer process and treatment 900, according to one embodiment.

FIG. 10 is a view of cancer process and without treatment 1000, in one embodiment.

FIG. 11 is a view of cancer process and treatment with cellular medicine 1100, in one embodiment.

Other features of the present embodiments will be apparent from the accompanying drawings and from the detailed description that follows.

### DETAILED DESCRIPTION

Several method and systems for integrated and interactive modules using modular multimedia informational tools for medical, physiological and pathological conditions for the disease state are disclosed. The embodiments also describe the traditional/conventional treatment methods, current treatment methods and cellular medicine based treatment methods and their disadvantage and advantages are simulated. Although the present embodiments have been described with reference to specific example embodiments, it will be evident that various modifications and changes may be made to these embodiments without departing from the broader spirit and scope of the various embodiments.

Cellular medicine in this disclosure may be described as a term used synonymously for any preventive or therapeutic measure using micronutrients or other natural compounds to affect or modulate physiological or pathological conditions at the cellular, organ or system level (entire human body).

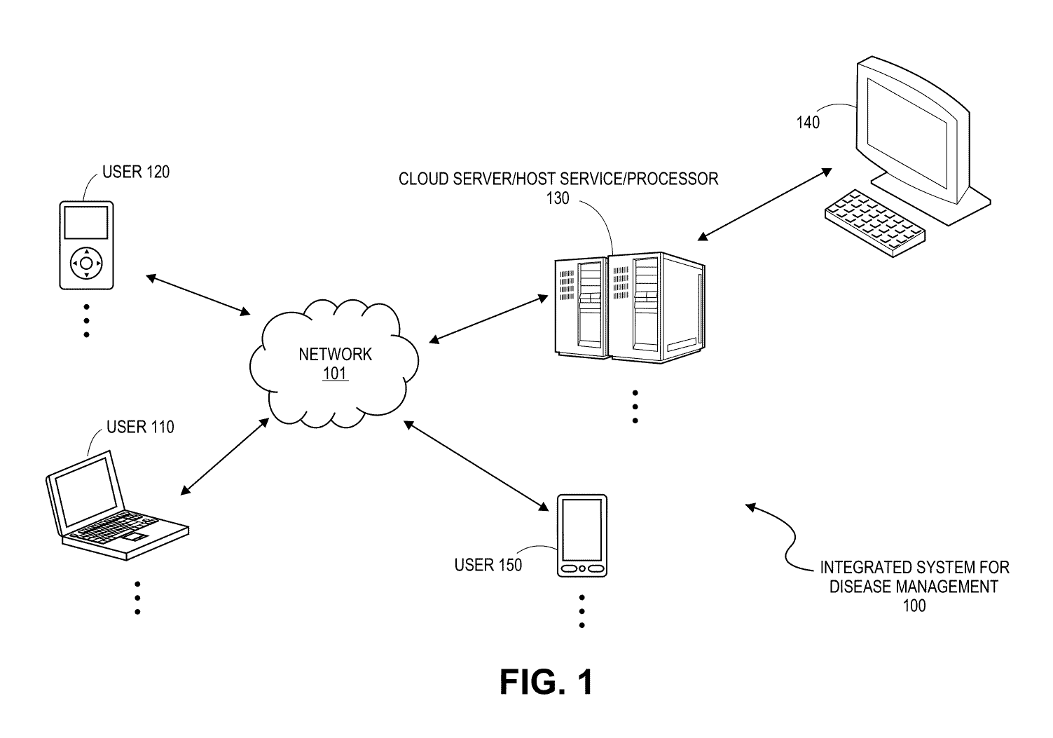

FIG. 1 is a systematic view of an integrated system for disease management 100 illustrating communication between user and the server through a network, according to one embodiment. In one embodiment a user or multiple users may connect to the server that hosts the multimedia tool in the system. In another embodiment, the user hard ware such as a PDA, mobile device such as tablets etc., computer or a mobile phone or any wireless device, or an electronic book (e-book) may be connected with each other or work independently to allow the user to use the multimedia tool for education, learning, and/or interactively playing games. The network 110 may be a LAN, WAN, mobile, telecommunications, internet, intranet, WiFi and/or ZigBee network, etc. The user/individual 110, 120 and 150 and so on may be an individual, a parent, a scientist, an author, but not limited to these group of folks only. The user and individual are used interchangeably and mean the same. The user may be any person who accesses the multimedia informational tool for educational, recreational, treatment mode assessment and to make informed decisions. The informational tool may be accessed to search, create content, upload content, view content, use the content and save and/or delete the content. The server may be stand alone, cloud based or hosted services.

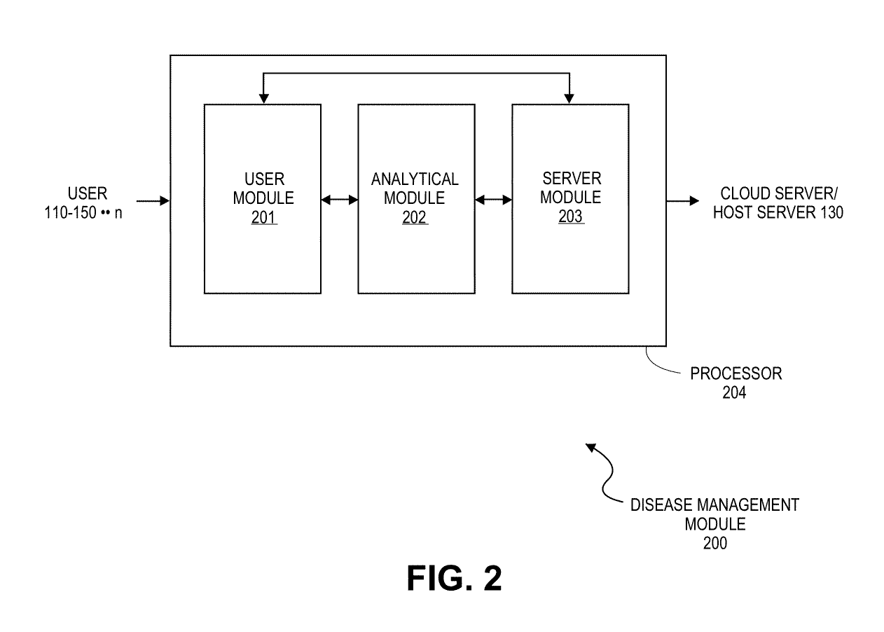

FIG. 2 illustrates an exploded view of the disease management module, according to one embodiment. In one embodiment, a disease management module 200 may allow connectivity to a user 110-N through a network 110. The user may have several types of devices such as an electronic book, mobile device, phone, computer, video game console, and PDA (Portable Digital Assistant), etc.

In one embodiment, the disease management module 200 may include a user module 201, analytical module 202, and a server module 203. All three modules are housed in a processor 204 of any device or platform. All three modules and other modules are interdependent and/or independent during operation and/or installation.

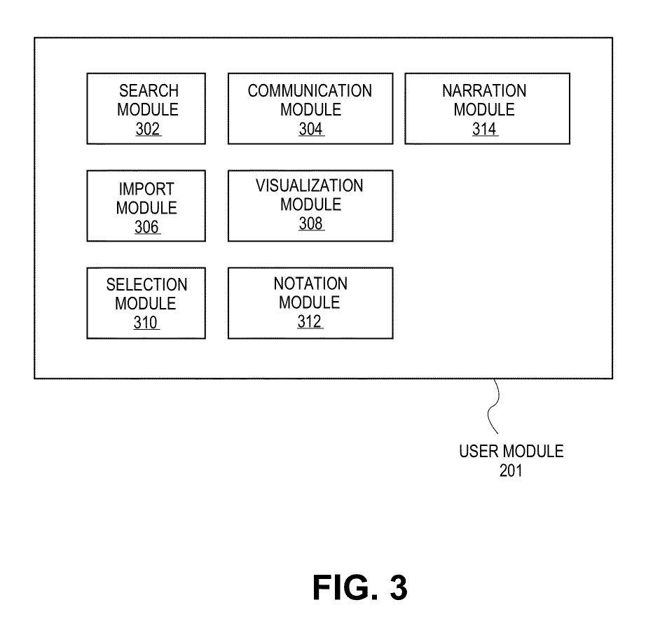

FIG. 3, the user module 201 comprises of several modules embedded within and are interconnected for functionality. The search module 302 is a novel entity that allows user to search either through text search, voice activated search and/or input image search. Once a user inputs the search criteria several algorithms as methods and systems are activated. In one embodiment, determination of user reading speed vs usability is calculated to understand the interest of the user for a particular topic. By measuring the time the user is spent on a specific click on a web site or a topic is calculated based on measuring the time between activating the link to get the article and the click on to the next link. Once a user profile is calculated on several uses it may also be statistically calculated based on user behavior. The user behavior may also be assessed by asking if the article is of relevance or not by providing a simple radio button before the user can browse over to the next page or close the browser. Once this mathematical calculation is gathered for a number of times the user profile may be stored with behavior pattern and may be used to provide relevant information to the user the next time around. The informational tool is partially self learning as well due to these inbuilt mathematical functions. More details of this search module will be discussed along with other figures below.

The communication module 304 enables the user to communicate with other users, social media sites, network and among their own interest groups and/or other users. Import module 306 allows the user to import text, images, documents, books etc., electronically into their user logged in account. It also enables them to communicate within and outside the informational tool. The visualization module 308 allows the user to view the retrieved information after the user has entered, selected or created the content. The user profile, entered data and the usability data is calculated and pertinent data is displayed using the visualization module. The notation module 312 allows the user to input and annotate the sections of interest to blog or record. The narration module 314 also allows the user to select the text as a display, verbal narration or both for a particular section related to a disease, traditional/conventional treatment or cellular medicine options. The narration module may also suggest to the user the pertinent web sites they can go to for further information, retrieve research articles, invite experts to weigh in, direct the user to the nearest commercial entity that provides the needed goods or services to the user related to the query. The selection module 310 enables the user to navigate between various sections, diseases, views etc. In this entire application traditional and conventional medicine are used interchangeably.

In one embodiment, there may be more than one user at a particular place in the virtual human body interacting or narrating the events or observing the effect of change in the physiological condition, pathological condition or the functioning of the normal human body functions inside a virtual human body. As an example, the effect of micronutrient concentration increase in preventing plaque formation may be observed by the user who is travelling inside the virtual human artery. In another example the effect of a heart attack may be felt by the red blood shaped space ship as crushing effect and a jolt and/or narrowing of the artery. These are examples and the embodiments are not limited to these examples. An individual is a user, teacher, patient, software developer, system manager and not limited to these definitions. The user can zoom into a particular scene or place of interest and interactively see and collaborate with others. The user can invite others in a game like fashion to fight a particular disease with the help of others. They can choose a special format for travel such as a submarine, person or a vehicle.

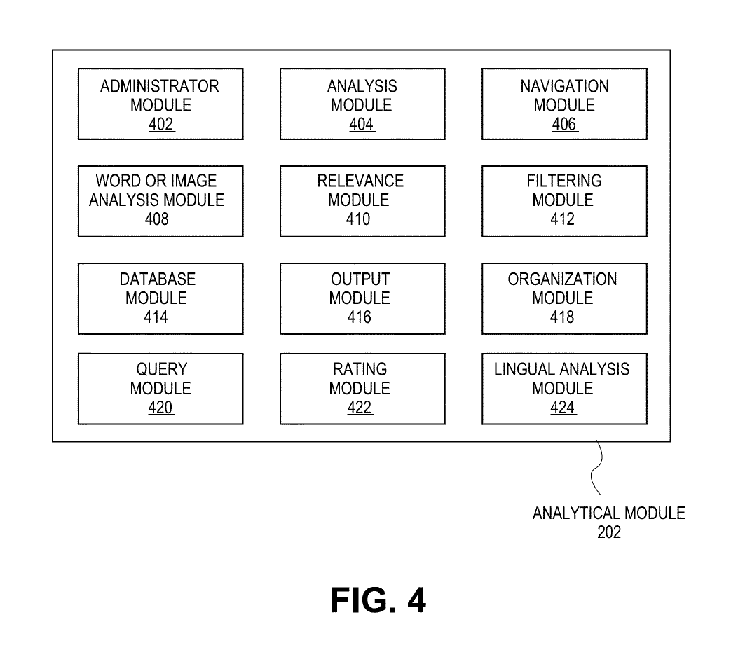

FIG. 4, the analytical module 202 comprises of various components such as administrator module 402, analysis module 404, navigation module 406, word or image analysis module 408, relevance module 410, filtering module 412, database module 414, output module 416, organization module 418, query module 420, rating module 422 and lingual analysis module 424.

The administrator module 402 allows the individual who is in charge of the managing the entire integrated system for disease management 100 to set preferences, uploads, security and work flow permissions for users and external participants. The content uploaded or entered by the user is analyzed by the analysis module 404. The user may upload texts, articles, blogs, pictures with captions, pictures, links to videos with or without caption. The analysis module 404 helps analyzing texts by a counting process or building a lexicon in the database. Lexicon building helps in storing the text in a string form with nearest word correlation.

The navigation module 406 allows the user not only to select a particular topic of interest when they enter the informational tool program but also allows them to select preferences. The preferences may be but not limited to language, chapter, topic, narration, web access, blog capability etc. The word and/or image module 408 allows the user to import any type of file to be entered. Once the files are entered the files are either reformatted to suit the informational tool format or API are developed to accommodate any file format and imported into the informational tool software.

The filtering module 412 allows the administrator to set limits to the string selection from the entered texts or images and calculate sub-strings for the same selection to create a lexicon and store it using the database module 414. This way the system is not overloaded and there is no security breach. This may be achieved by using security module 504 as well. The relevance module 410 builds the string and substring for the query entered by the user and stores the behavior pattern of the user using the database module 414. The query module 420 enables the user input to be calculated, entered, ranked, matched using the rating module 422, relevance module 410, word and/or image module 408 and analysis module 404. One may also augment these modules by supporting them with web based thesaurus, dictionary, encyclopedia etc. Lingual analysis module 424 allows the informational tool to have multiple language support system for query, narration and display. It is modular in nature so new languages may be uploaded when new commercial areas are entered. The lingual analysis module 424 may also translate if necessary from English to native languages such as German, French and Spanish (but not limited to just these languages). It may also reverse the translation for display and narration. The lingual analysis module may also help build word family associations and combine articles of similar subjects.

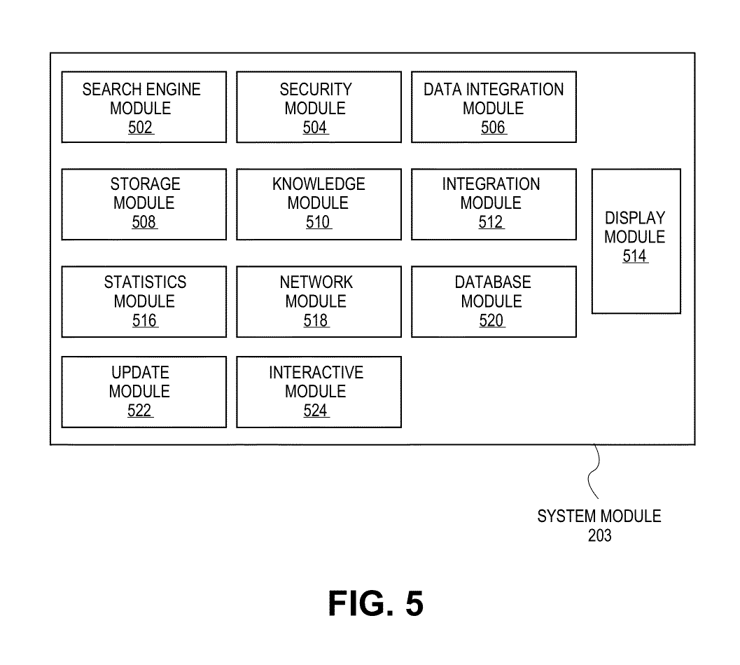

FIG. 5, the system module 203 comprises of search engine module 502, security module 504, data integration module 506, storage module 508, knowledge module 510, integration module 512, display module 514, statistics module 516, network module 518, database module 520, update module 522, interactive module 524.

The query entered by the user is used by the search engine module 502 to not only access the database module 520 and the update module 522 to retrieve information using the display module 514 to present it to the user. The data produced by the search engine module 502 is stored in the database module 520 as well to be used by analytical module 202.

The data integration module 506 allows the integrated system for disease management to combine disparate data and enable integration module 512 to format the data for software and hardware entities of the system. The integration module 512 on manages just the data integration from disparate sources.

Statistics module 516 helps the analytical module 202 to perform at its best and optimizes resources and processing capabilities for the data that is being managed by the system module 203. Display module 514 allows the files and formats created by different modules for the user to visualize, interact and share information and files using the interactive module 524. The interactive module 524 also allows the user to communicate with other users, web and blogs. Knowledge module 510 assembles the data produced by the analytical module 202 and in conjunction with update module 522 keeps the data current for the storage module 508, database module 520 and integration module 512 so that analytical module 202 would provide the most relevant and updated data to be presented to the user. This whole system may reside inside a social media web page of an individual as an icon and can be started when one clicks on it. This may also appear as an application for mobile devices or it may be a standalone application or a web based application for the user to access and use.

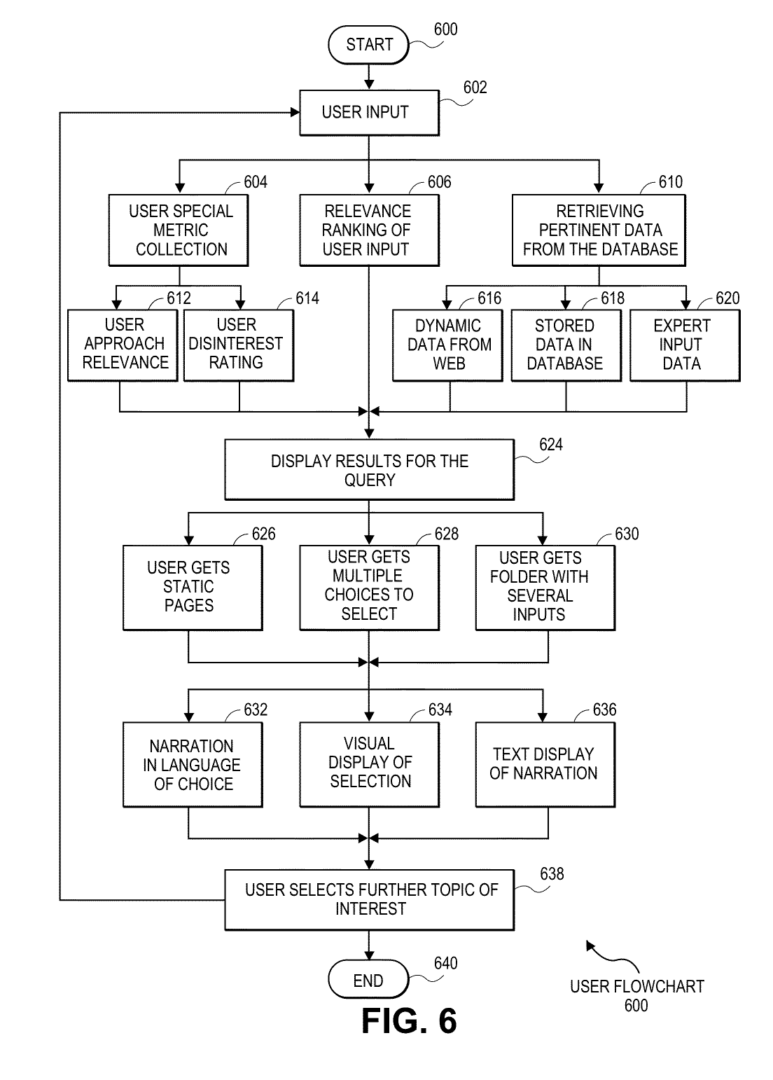

FIG. 6, shows a user flow chart 600 as an example how the workflow might take place for a given scenario. A user may login to their account or use the application on their hardware device and input 604 a query in the format of a text, chat or an image file. The disease management module 200 uses the information and collects user specific metric collection 604 for the analytical module 202 and the system module 203 to use. Relevance ranking 606 is performed using the user input and pertinent data is retrieved using both the 604 and 606 data collection or separately. For display purposes retrieval of pertinent data from the database 610 that has been either populated by using dynamic data from web 616 step and/or stored data in the database 618 (which may also be curated data) and expert input data 620 either dynamically or cached from various resources may be performed. The results are displayed for the query 624. The user is presented the result as a static page 626, the user may get multiple choices to select from 628 and/or user gets the input in folder format 630. The user may choose to compile, print, store or export it another document or file of interest at this point. The user may simply move forward to listen to the narration in language of choice 632 for the displayed results, choose a visual display for the selection 634 or elect a text display of the narration 636. Once the user has completed the task at hand they may want to proceed with another query 638 or simply choose to end 640 the session. This particular version of the query, its display, the browsing history etc for that particular is stored so that analytical module may use this information for future.

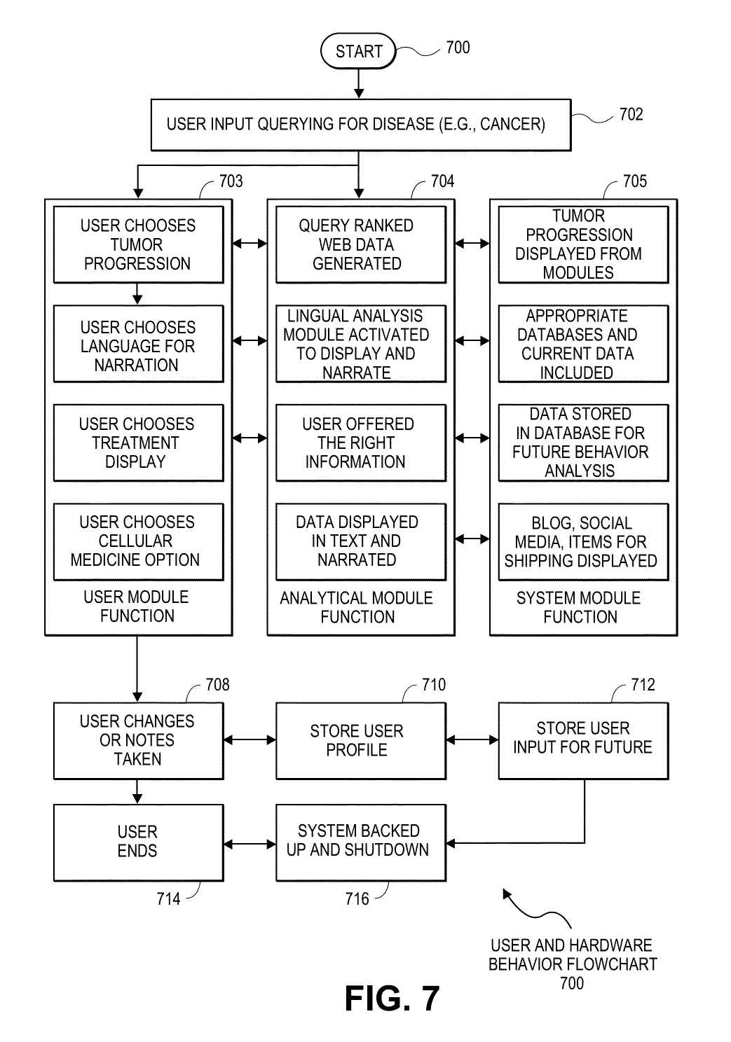

FIG. 7, shows the flow of data between the user behavior and hardware function interaction 700. In this flow chart an example of the cancer progression is chosen. User in user module function 703 has several steps that works with analytical module function 704 and which in turn uses system module function 705. System module function 705 also supports user module function 703. Various modules described and shown above are interlinked in this flow chart and shows how all three function modules work together as an integrated unit. User changes or notes taken 708 function performed by user is stored as a user profile 710 and used as an input for future 712. The system is backed up 716 once the user decides to end the session 714.

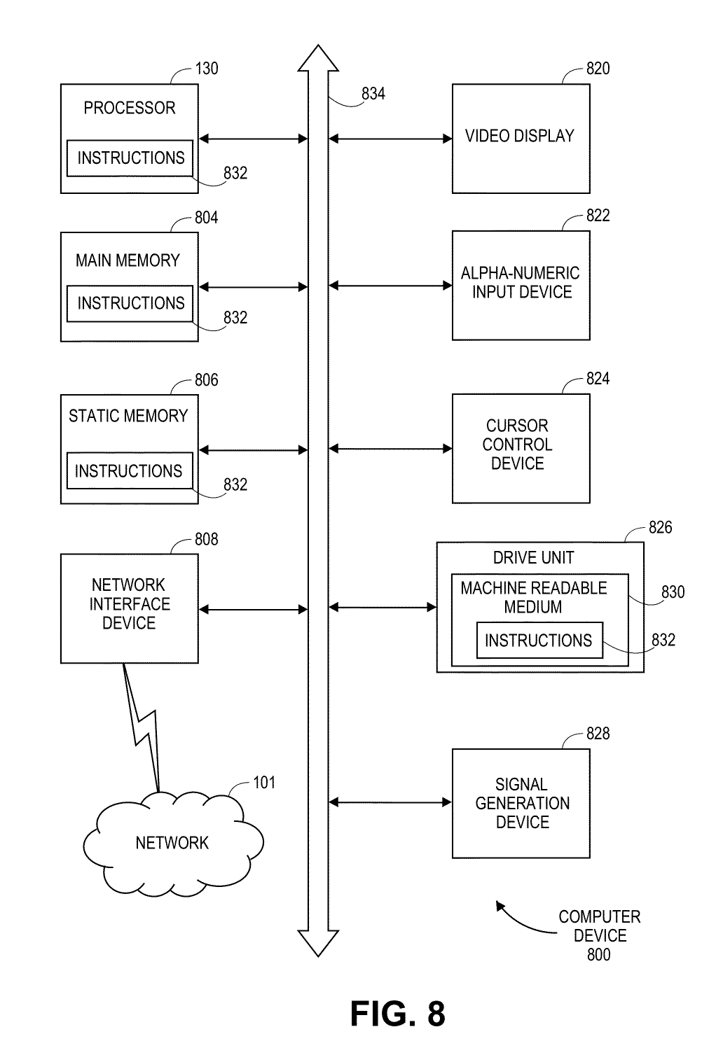

FIG. 8 is a diagrammatic system view 800 of a computer device view in which any of the embodiments disclosed herein may be performed, according to one embodiment. Particularly, the computer system view 800 of FIG. 8 illustrates a processor 130, a main memory 804, a static memory 806, a bus 834, a video display 820, an alpha-numeric input device 822, a cursor control device 824, a drive unit 826, a signal generation device 828, a network interface device 808, a machine readable medium 830, instructions 832, and a network 101, according to one embodiment.

The computer system view 800 may indicate a personal computer and/or a data processing system (e.g., server) in which one or more operations disclosed herein are performed. The processor 130 may be microprocessor, a state machine, an application specific integrated circuit, a field programmable gate array, etc. The main memory 804 may be a dynamic random access memory and/or a primary memory of a computer system. The static memory 806 may be a hard drive, a flash drive, and/or other memory information associated with the computer system. The bus 834 may be an interconnection between various circuits and/or structures of the computer system. The video display 820 may provide graphical representation of information on the data processing system. The alpha-numeric input device 822 may be a keypad, keyboard and/or any other input device of text (e.g., a special device to aid the physically handicapped). The cursor control device 824 may be a pointing device such as a mouse.

The drive unit 826 may be a hard drive, a storage system, and/or other longer term storage subsystem. The signal generation device 828 may be a bios and/or a functional operating system of the data processing system. The network interface device 808 may be a device that may perform interface functions such as code conversion, protocol conversion and/or buffering required for communication to and from a network (e.g., the network 101 of FIG. 1). The machine readable medium 830 may provide instructions on which any of the methods disclosed herein may be performed. The instructions 832 may provide source code and/or data code to the processor 130 to enable any one/or more operations disclosed herein.

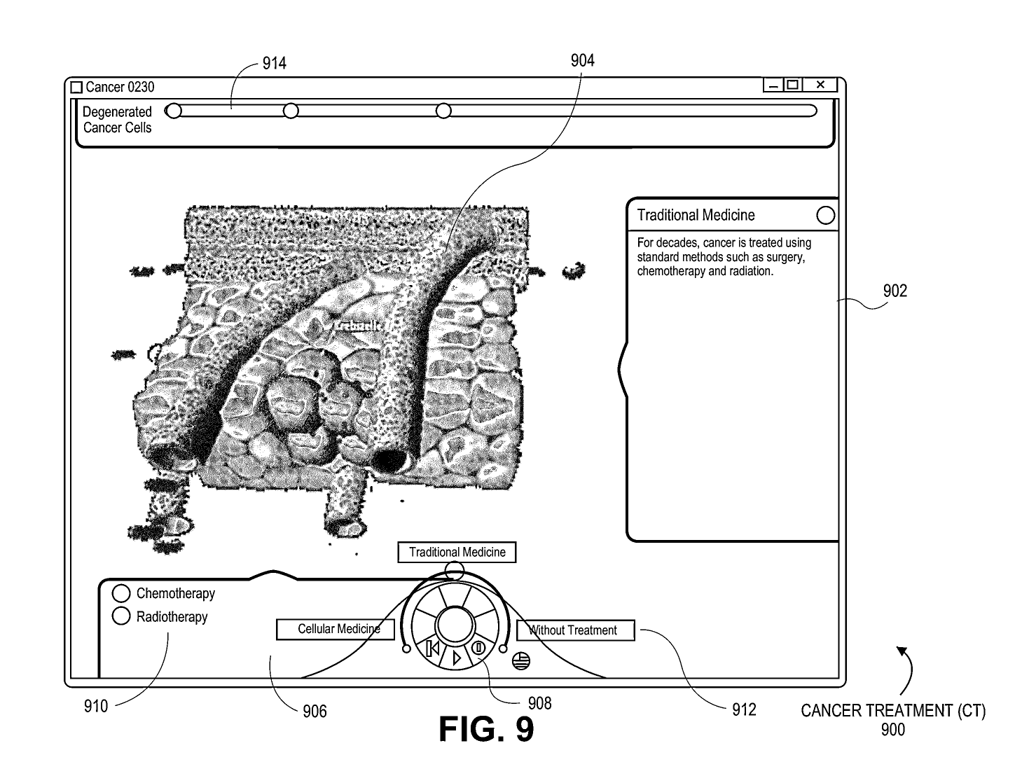

FIG. 9, is a graphical user interface of a cancer session being used by the user. The user may elect to tour the virtual human body at cellular level, system level and/or an organ level and/or molecular level. The cellular level components are at least one of nuclei, nucleoli (within nucleus), rough endoplasmic reticulum (ER), smooth ER, ribosomes, cytoskeleton, golgi apparatus, cytoplasm, mitochondria, vesicles, lysosomes, centrosome, centrioles, red blood cells, white blood cells, bacteria, virus, t-cells, macrophages and phagocytes. The system level is at least one of circulatory system, respiratory system, digestive system, musculoskeletal system, endocrine system, integumentary system, immune system, lymphatic system, reproductive system, urinary system, vestibular system and nervous system. The organ level is at least one of a brain, basal ganglia, brain stem, medulla, midbrain, pons, cerebellum, cerebral cortex, hypothalamus, limbic system, eye, pituitary, thyroid, parathyroids, ears, heart, lung, esophagus, thymus, pleura, adrenals, appendix, bladder, gallbladder, large intestine, small intestine, kidney, liver, pancreas, spleen, stomach, prostate, testes, ovaries, uterus, breasts, hips, legs and throat. These are just representative examples and not limited to only these examples. The display module may allow the content manager, patient and/or the user to pick a certain shape of exploration shape or transportation system of choice inside the body, pick a location to enter or exit a system, an organ or a cellular space or an organelle to be representing the as a observer. For example, a user can pick an exploration shape to be like a space ship, mitochondria, a red blood cell, or a micronutrient. This imaginative shape allows the user to learn and observe the physiological function, pathological function, or system maintenance aspect of the virtual human body. The interactive module also enables the user, creator, and the patient to listen to the narration of the events in an audio file as the chosen imaginative shape travels through the virtual human body. The diseases are at least one of autoimmune diseases, cancer types, communication disorders, cutaneous conditions, metabolic disorders, endocrine diseases, eye diseases and disorders, genetic disorders, infectious diseases, intestinal diseases and neurological disorders.

In one embodiment, there may be more than one user at a particular place in the virtual human body interacting or narrating the events or observing the effect of change in the physiological condition, pathological condition or the functioning of the normal human body functions inside a virtual human body. As an example, the effect of micronutrient concentration increase in preventing plaque formation may be observed by the user who is travelling inside the virtual human artery. In another example the effect of a heart attack may be felt by the red blood shaped space ship as crushing effect and a jolt and/or narrowing of the artery. These are examples and the embodiments are not limited to these examples. An individual is a user, teacher, patient, software developer, system manager and not limited to these definitions.

In one embodiment, the social media access ability may allow the user to invite and/or allow others to join the user while the user is travelling through the virtual human body. They may role play and learn a particular topic or just be part of a game. An advertisement opportunity may also allow advertisers to mine the trend, suggest retail options for the user to buy a particular drug, exercise place or a health food store or restaurant and guide them using global positioning system to that address. In another embodiment, an advertisement module of the content module to enable a service provider to at least one of to advertise, sell and connect the individual to a location for their need of an item pertaining to a current instance that is happening in the modular multimedia tool. The current instance happening may be something a user is being researching for or playing a game of cause and effect.

The disease management system tool may be modular, scalable and integrated for using at different platforms. Cancer treatment (CT) 900 is a graphical interface presentation of the cancer related session. The upper bar labeled 914 shows the progress of different narrations. The 904 is a graphical representation of a bed of cells that are being attacked by carcinogens. Number 914 shows the progress of the cancer in different stages as the disease progresses from Stage 1 Growth of tumor, Stage 2 Metastasis of tumor, Stage 3 Angiogenesis. A non linear control is implemented by the system such that it enables the user to switch between various disease stages and observe the changes, treatment and cellular medicine treatment and recommendations. Additional information is provided in the text box on the side. This enables different types of communication channels for user to feel comfortable and understand. One may also switch languages depending on the preference of the user in the text boxes and narrations.

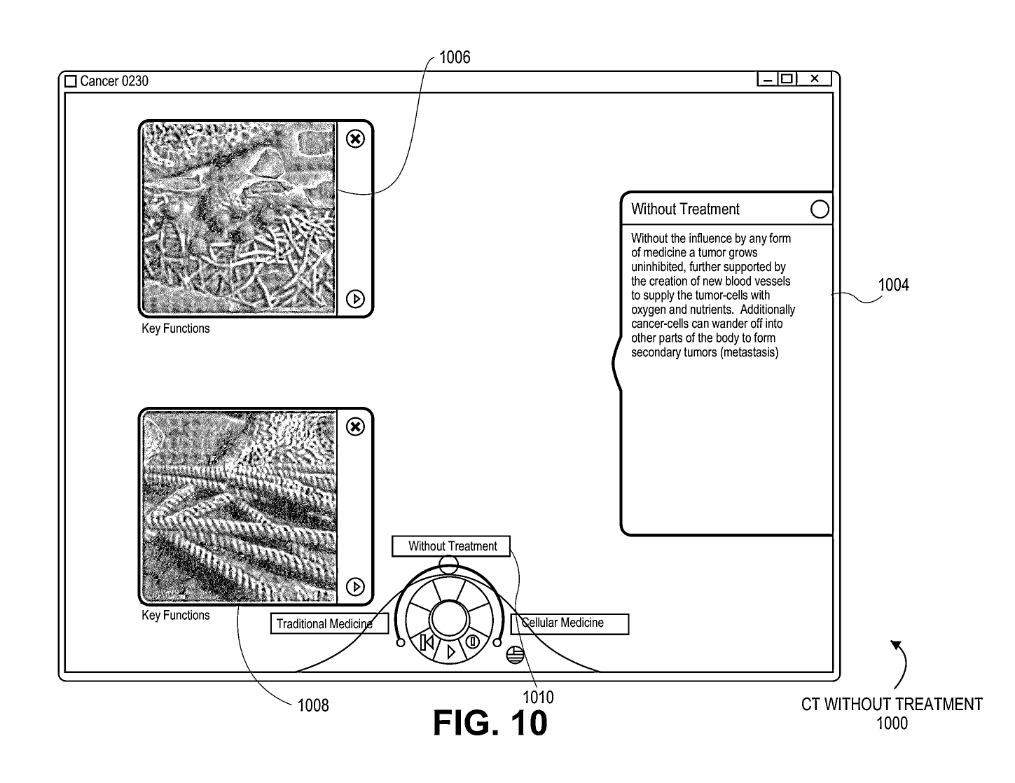

FIG. 10 shows cancer progression without the treatment 1000. The dial 908 is in the 1010 without treatment position and the text box 1004 describes what happens when there is no treatment then tumor growth is uninhibited. The two boxes 1006 and 1008 are depicting the pictoral format of the events when the tumor cells are growing and damaging the connective tissue surrounding it in order to continue their growth and digest it.

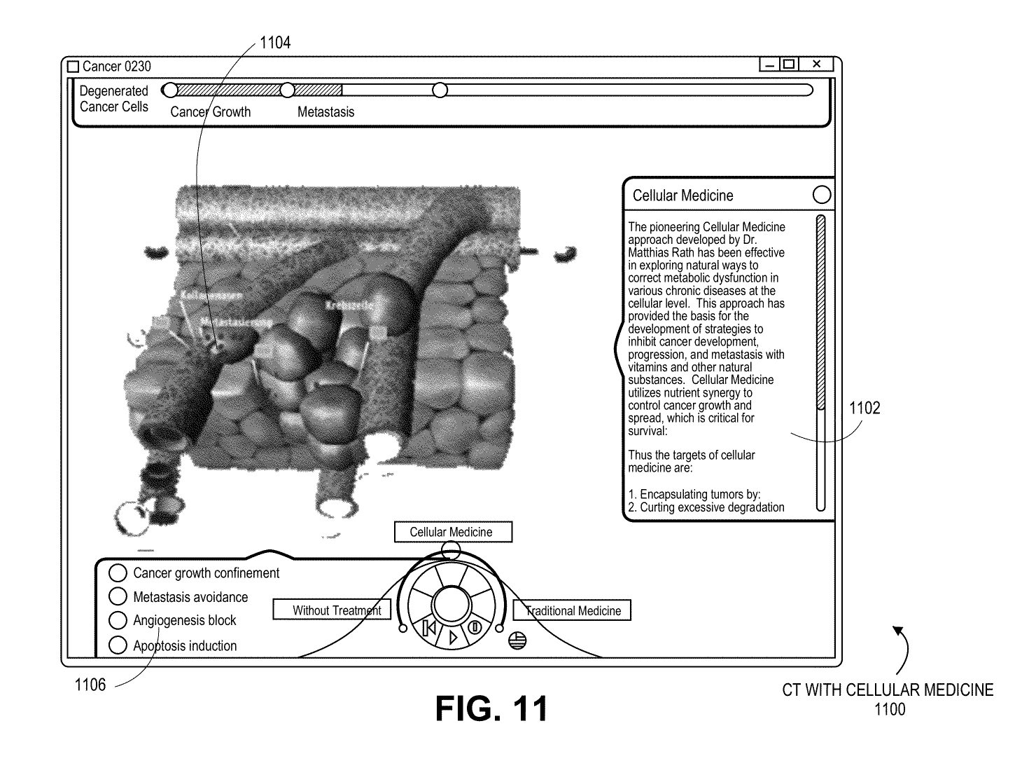

In FIG. 11 the dial 908 is in Cellular medicine mode showing cancer treatment with cellular medicine 1100. 1104 shows how cellular medicine curbs the excessive degradation and encapsulates the tumor using nutrient synergy as stated in text box 1102. The different stages on prevention and treatment can be seen by selecting the various stages of cancer using the radio buttons as shown in 1106.

As an another example of this system, process and method of the instant application FIG. 12 shows a cellular level exploration capacity by providing cellular level view 1200. The internal mileu of the organ 1201 can be zoomed out to see a cell membrane 1202. The integrated tool allows the user to remove a thin veil of the cell membrane 1202 up and out to see the internal contents of the cell such as 1204 and cytoplasm 1203. In the instant example the system and the tool allows the user to explore the structure and function of the cell and understand the working of it. It may also (not shown) allow the user to see the onslaught of either one of the toxic chemicals and disease conditions or both and how they change this component of the body.

FIG. 13 depicts the Arteriosclerosis model 1300. This example shows that the user can perform a simulation of the heart attack or arteriosclerosis formation by varying the heart rate, heart beat, level of cholesterol in the blood, (1302) etc. The pumping of the blood may be seen to alter in a 3D depiction of the heart 1308. The heart can be also observed by revealing the interior chambers of the heart. A text box 1310 would allow display of pertinent text based on the input and graphical representation of heart rate 1304 can be observed as well.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, apparatuses and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method of presenting human physiology, comprising:
rendering an interactive physiological model of the human body using a modular integrated tool running on a processor;
dynamically updating a relevant data pertaining to a normal, disease and treatment option; and
permitting a user to query and explore the interactive physiological model of the human body at a system, organ, cellular and molecular level.

2. The method of claim 1, further comprising:
allowing the user to travel throughout the human body in a special format, wherein the special format is at least one of a submarine, small vehicle and animated object of choice.

3. The method of claim 1, further comprising:
presenting a graphical data, a textual data, and a narrative pertinent to a user query; and
providing access for a product provider to a user session for monetization.

4. The method of claim 1, further comprising:
layering a visual rendering for the user at the organ and cellular level; and
changing language display depending on a user choice.

5. The method of claim 1, wherein the treatment option is at least one of a traditional and cellular medicine.

6. An integrated system, comprising:
a machine readable media comprising of a disease management module for visualizing and interacting with a graphical rendition of a human physiology, disease and treatment option.

7. The integrated system of claim 6, further comprising:
a user module, analytical module and system module forms the disease management module.

8. The integrated system of claim 7, wherein the user module comprises of a search module for the user to input a query to extract pertinent graphical rendition of the human physiology, wherein the search module also enables statistical analysis of a user behavior to present relevant information to the user.

9. The integrated system of claim 6, wherein the analytical module comprises of a lingual analysis module that helps elect and select the language of choice for the user.

10. The integrated system of claim 6, wherein the system module comprises of a knowledge module that assembles data produced by the analytical module to provide the most relevant data and updated data to the user.

11. A method of using an integrated human physiology tool, comprising:
entering a query to retrieve a graphical rendition of a system, organ and cell;
visualizing the graphical rendition of the system, organ and cell;
peeling an upper layer using the cursor to enter a lower layer of at least one of the organ and cell to visualize in more detail; and
gathering information from at least one of a social media, literature, curated data and internet data to make an informed decision for a disease and a treatment option.

12. The method of claim 11, wherein the treatment option is cellular medicine, wherein the disease is at least one of atherosclerosis and cancer.

13. The method of claim 11, further comprising:
modulating a parameter to observe a resulting change in at least one of the system, organ and cell;
reading a textual information for a current status;
listening to a narration for the current status; and
searching the social media, literature, curated data and internet data to make an informed decision.

14. The method of claim 13, wherein the parameter is any physiological condition such as blood pressure, blood component and heart rate.

15. The method of claim 13, further comprising:
observing the progression of a disease by choosing a specific topic, wherein the topic is at least one of a metabolic disease disorder such as diabetes, a infectious disease such as influenza and a chronic disease such as cancer and arteriosclerosis.

16. The method of claim 15, further comprising:
enquiring other users on the internet about the specific disease and treatment option and getting a feed back from informed sources.

17. The method of claim 16, further comprising:
interacting with other users to form a team and fight the disease with several options available to the users in a gaming like style.

18. The method of claim 16, wherein the informed sources are at least one of an expert, literature and physician.
